(19) United States
(12) Patent Application Publication
(10) Pub. No.: US 2017/0314493 A1
(43) Pub. Date: Nov. 2, 2017

(54) INTERNAL COMBUSTION ENGINE

(71) Applicant: TOYOTA JIDOSHA KABUSHIKI KAISHA, Toyota-shi (JP)

(72) Inventors: Keiji YOEDA, Numazu-shi (JP); lsao MATSUMOTO, Shizuoka-ken (JP)

(73) Assignee: TOYOTA JIDOSHA KABUSHIKI KAISHA, Toyota-shi (JP)

(21) Appl. No.: 15/499,405

(22) Filed: Apr. 27, 2017

(30) Foreign Application Priority Data
May 2, 2016 (JP) 2016-092578

(51) Int. Cl. F02D 41/22; F02D 41/00; F02D 13/02; F02B 37/18; F02D 41/38; F01N 13/10

(52) U.S. Cl. CPC F02D 41/221; F02D 41/38; F02D 41/0007; F01N 13/107; F02D 13/0215; F02B 37/183; F02D 13/0261

(57) ABSTRACT

An internal combustion engine includes a twin entry type turbocharger with which a first exhaust passage and a second exhaust passage respectively communicate individually, a communication path that causes the first exhaust passage and the second exhaust passage to communicate with each other, a communication valve that opens and closes the communication path, an abnormality diagnosis device that diagnoses presence or absence of abnormality of the communication valve, a variable valve timing mechanism capable of changing a period of valve overlap of the engine, and a control device. When it is determined that abnormality of a valve closure failure of the communication valve is present, the control device operates the mechanism to reduce the valve overlap in an operating state in which the communication valve is closed, more than in a case where it is determined that abnormality of a valve closure failure of the communication valve is absent.

### FIELD

The present disclosure relates to an internal combustion engine, and particularly relates to an internal combustion engine including a twin entry type turbocharger.

### BACKGROUND

Conventionally, Patent Literature 1, for example, discloses an art relating to an engine equipped with a twin entry type turbocharger. An exhaust manifold of this engine is formed to collect exhaust passages of cylinders that do not cause exhaust interference, which are respectively caused to communicate with two exhaust passages that are included by the twin entry type turbocharger via communication pipe. Further, the communication pipe is provided with a change-over valve for causing both the exhaust passages to communicate with each other or to be shut off from each other. The change-over valve is controlled to shut off communication of both the exhaust passages in a small exhaust gas flow rate region of the engine, and to cause both the exhaust passages to communicate with each other in a large exhaust gas flow rate region of the engine.

Following is a list of patent literatures which the applicant has noticed as related arts of embodiments the present disclosure.

Patent Literature 1: JP 63-117124 A

Patent Literature 2: JP 2003-328765 A

Patent Literature 3: JP 2013-256895 A

### SUMMARY

In the engine of Patent Literature 1 described above, the engine output power can be enhanced without causing exhaust interference in the small exhaust gas flow rate region, and in the large exhaust gas flow rate region, the engine output power can be increased efficiently by reducing exhaust resistance.

However, in the communication valve that provides communication between the exhaust passages which are independently connected to a twin entry type turbocharger, like the change-over valve in Patent Literature 1 described above, there arises the problem of occurrence of a malfunction. That is, since the communication valve is a movable component that is disposed in the exhaust passage with a high temperature, there is the fear of occurrence of a failure in which valve closure becomes insufficient although the operating state is such that the valve should be closed (hereinafter, referred to as “a valve closure failure”), and a failure in which valve opening becomes insufficient although the operation state is such that the valve should be opened (hereinafter, referred to as “a valve opening failure”). When abnormality of a valve closure failure occurs to the communication valve, the exhaust capacity becomes larger than in the case of the communication valve being closed, so that expansion work in the turbine decreases and turbocharging performance is reduced. Further, when abnormality of a valve closure failure occurs to the communication valve, the exhaust port pressure at the time of valve overlap of the other cylinders is enhanced, and therefore, reduction in volume efficiency and occurrence of a misfire due to increase in the residual gas in the other cylinders become problems.

The present disclosure is made in the light of the problems as described above, and has an object to provide an internal combustion engine capable of restraining engine performance from being reduced by a malfunction of a communication valve in the internal combustion engine including the communication valve that provides communication between exhaust passages that are independently connected to a twin entry type turbocharger.

In accomplishing the above object, according to a first aspect of the present disclosure, there is provided an internal combustion engine, including:

a first exhaust passage in which gas flows, which is discharged from a first cylinder group of the internal combustion engine including a plurality of cylinders;

a second exhaust passage in which gas flows, which is discharged from a second cylinder group that is configured by cylinders different from the first cylinder group;

a turbocharger with which the first exhaust passage and the second exhaust passage respectively communicate individually;

a communication path that causes the first exhaust passage and the second exhaust passage to communicate with each other;

a communication valve that opens and closes the communication path;

an abnormality diagnosis device that diagnoses presence or absence of abnormality of the communication valve;

a variable valve timing mechanism capable of changing a period of valve overlap in which an intake valve and an exhaust valve of the internal combustion engine are both in a valve opened state; and

a control device that opens and closes the communication valve and operates the variable valve timing mechanism, based on an operating state of the internal combustion engine,

wherein, when it is determined that abnormality of a valve closure failure of the communication valve is present by the abnormality diagnosis device, the control device operates the variable valve timing mechanism to reduce the valve overlap in an operating state in which the communication valve is closed, more than in a case where it is determined that abnormality of a valve closure failure of the communication valve is absent.

According to a second aspect of the present disclosure, there is provided the internal combustion engine according to the first aspect, further including:

an ignition device that performs ignition to a gas mixture in a combustion chamber of the internal combustion engine,

wherein, when it is determined that abnormality of a valve closure failure of the communication valve is present by the abnormality diagnosis device, the control device operates the ignition device such that an ignition timing is retarded more than in a case where it is determined that abnormality of a valve closure failure of the communication valve is absent.

According to a third aspect of the present disclosure, there is provided the internal combustion engine according to the first or second aspect,

wherein the variable valve timing mechanism is capable of changing a valve opening timing of the exhaust valve, and

when it is determined that abnormality of a valve closure failure of the communication valve is present by the abnormality diagnosis device, the control device operates the variable valve timing mechanism to advance the valve opening timing of the exhaust valve in the operating state where the communication valve is closed, more than in the case where it is determined that abnormality of a valve closure failure of the communication valve is absent.

According to a fourth aspect of the present disclosure, there is provided the internal combustion engine according to any one of the first to third aspects,

wherein the communication path includes

an auxiliary chamber,

a first communication path that causes the first exhaust passage and the auxiliary chamber to communicate with each other, and

a second communication path that causes the second exhaust passage and the auxiliary chamber to communicate with each other,

wherein the communication valve is configured to perform opening and closing of the first communication path and the second communication path, and

the abnormality diagnosis device

is configured to include a sensor for detecting a state parameter expressing a state of gas in the auxiliary chamber, and diagnose presence or absence of abnormality of the communication valve based on a change over time of the state parameter detected by the sensor.

According to a fifth aspect of the present disclosure, there is provided the internal combustion engine according to any one of the first to fourth aspects,

wherein the variable valve timing mechanism is capable of changing a valve opening timing of the exhaust valve, and

when it is determined that abnormality of a valve opening failure of the communication valve is present by the abnormality diagnosis device, the control device operates the variable valve timing mechanism to advance the valve opening timing of the exhaust valve in an operating state where the communication valve is opened, more than in a case where it is determined that abnormality of a valve opening failure of the communication valve is absent.

According to a sixth aspect of the present disclosure, there is provided the internal combustion engine according to any one of the first to fourth aspects, further including:

a bypass passage that communicates with an exhaust passage downstream of the turbocharger from the first exhaust passage and the second exhaust passage; and

a waste-gate valve for adjusting an opening degree of the bypass passage,

wherein, when it is determined that abnormality of a valve opening failure of the communication valve is present by the abnormality diagnosis device, the control device adjusts an opening degree of the waste-gate valve in an operating state where the communication valve is opened, to an opening side more than in a case where it is determined that abnormality of a valve opening failure of the communication valve is absent.

According to a seventh aspect of the present disclosure, there is provided the internal combustion engine according to the fifth or sixth aspect, further including:

a fuel supply device that adjusts a fuel supply amount to a combustion chamber of the internal combustion engine,

wherein the control device is configured to control the fuel supply device to increase a fuel supply amount to the combustion chamber, when it is determined that abnormality of a valve opening failure of the communication valve is present by the abnormality diagnosis device and the control device advances a valve opening phase of the exhaust valve.

When abnormality of a valve closure failure of the communication valve is present, an exhaust flow (hereinafter, referred to as “a blowdown flow”) that is exhausted in a vicinity of an intake top dead center of cylinders of the first cylinder group and before intake valve opening is propagated to the second exhaust passage. According to the first aspect of the present disclosure, when it is determined that abnormality of a valve closure failure of the communication valve is present, the valve overlap in the operating state in which the communication valve is closed is reduced more than in the case where it is determined that abnormality of a valve closure failure is absent. Thereby, the blowdown flow by the exhaust gas of the first cylinder group can be restrained from flowing around to the second cylinder group via the communication valve and the second exhaust passage during the overlap period of the second cylinder group, and therefore, it becomes possible to restrain occurrence of a misfire.

When the valve overlap is reduced, a ratio of burnt gas that stays in the cylinders increases, so that the temperature in the combustion chambers increases. According to the second aspect of the present disclosure, when it is determined that abnormality of a valve closure failure of the communication valve is present, the ignition timing is retarded. Thereby, it becomes possible to effectively restrain occurrence of knocking caused by reducing the valve overlap.

According to the third aspect of the present disclosure, the valve overlap is reduced by advancing the valve opening timing of the exhaust valve. When the valve opening timing of the exhaust valve is advanced, timing of occurrence of blowdown of the exhaust gas is advanced, so that it becomes possible to restrain a blowdown flow by the exhaust gas of the first cylinder group from flowing around to the second cylinder group via the communication valve and the second exhaust passage.

According to the fourth aspect of the present disclosure, the state parameter expressing the state in the auxiliary chamber changes in accordance with outflow and inflow of gas between the first exhaust passage or the second exhaust passage and the auxiliary chamber. Consequently, according to the present disclosure, it becomes possible to determine presence or absence of a valve opening failure or a valve closure failure of the communication valve with high precision, based on a change over time of the state parameter detected by the sensor.

According to the fifth aspect of the present disclosure, when it is determined that abnormality of a valve opening failure of the communication valve is present, the valve opening timing of the exhaust valve in the operating state where the communication valve is opened is advanced more than in the case where it is determined that abnormality of a valve opening failure is absent. Thereby, the pressure in the combustion chamber in the exhaust stroke can be reduced, and therefore it becomes possible to reduce pushing-out loss of exhaust gas and restrain reduction in output power.

According to the sixth aspect of the present disclosure, when it is determined that abnormality of a valve opening failure of the communication valve is present, the opening degree of the waste-gate valve in the operating state where the communication valve is opened is increased more than in the case where it is determined that abnormality of a valve opening failure is absent. Thereby, pushing-out loss of the exhaust gas can be reduced, and therefore, it becomes possible to restrain reduction in output power.

According to the seventh aspect of the present disclosure, the fuel supply amount that is supplied to the combustion chamber is increased, when the valve opening timing of the exhaust valve is advanced. When the valve opening timing of the exhaust valve is advanced, the exhaust temperature increases, and therefore the temperature of the catalyst is likely to increase excessively. According to the present disclosure, the fuel supply amount is increased in the case like this, and therefore it becomes possible to restrain excessive increase of the temperature of the catalyst.

### BRIEF DESCRIPTION OF DRAWINGS

FIG. 1 is a simplified view for explaining a configuration of an internal combustion engine as a first embodiment of the present disclosure;

FIG. 2 is a view schematically illustrating an internal structure of a turbine of a turbocharger of the first embodiment;

FIG. 3 is a sectional view of the turbine in FIG. 2 cut along line A-A in FIG. 2;

FIG. 4 is a flowchart of a control routine that is executed in a case of performing abnormality diagnosis of a communication valve;

FIG. 5 is a functional block diagram illustrating a configuration of an abnormality diagnosis device of the communication valve;

FIG. 6 is a diagram illustrating valve opening characteristics of intake valves and exhaust valves of respective cylinders of the internal combustion engine in a state where the communication valve is closed normally;

FIG. 7 is a view schematically illustrating a flow of gas in a cylinder in a valve overlap period, in the state where the communication valve is closed normally;

FIG. 8 is a view schematically illustrating a flow of gas in the cylinder in the valve overlap period, in a state where a valve closing failure occurs to the communication valve;

FIG. 9 is a diagram illustrating valve opening characteristics of the intake valves and the exhaust valves of the respective cylinders of the internal combustion engine in a state where a valve closure failure occurs to the communication valve;

FIG. 10 is a view schematically illustrating a flow of gas in the cylinder in the vicinity of an intake top dead center and before opening of an intake valve in a case where an opening and closing timing of the exhaust valve is advanced, in the state where a valve closure failure occurs to the communication valve;

FIG. 11 is a view schematically illustrating a flow of gas in the cylinder in the vicinity of the intake top dead center and after opening of the intake valve in the case where the opening and closing timing of the exhaust valve is advanced in the state where a valve closure failure occurs to the communication valve;

FIG. 12 is a diagram illustrating a pressure waveform of an exhaust port at a time of a high engine speed and a high load of a predetermined cylinder;

FIG. 13 is a diagram illustrating a pressure waveform of a cylinder pressure to a cylinder capacity at the time of a high engine speed and a high load of a predetermined cylinder;

FIG. 14 is a diagram illustrating a pressure waveform of the exhaust port at the time of a high engine speed and a high load of a predetermined cylinder;

FIG. 15 is a diagram illustrating a pressure waveform of a cylinder pressure to a cylinder capacity at the time of a high engine speed and a high load of a predetermined cylinder;

FIG. 16 is a flowchart of a control routine of control that is executed in a system of the first embodiment of the present disclosure;

FIG. 17 is a diagram illustrating a structure of a communication valve and a neighborhood of the communication valve as a modification example; and

FIG. 18 is a diagram illustrating a pressure change of a first exhaust passage, which is detected by a pressure sensor.

### DETAILED DESCRIPTION

Hereinafter, an embodiment of the present disclosure will be described with reference to the drawings. Note that when the numerals of the numbers, the quantities, the amounts, the ranges and the like of the respective elements are mentioned in the embodiment shown as follows, the present disclosure is not limited to the mentioned numerals unless specially explicitly described otherwise, or unless the disclosure is explicitly specified by the numerals theoretically. Further, the structures, steps and the like that are described in the embodiment shown as follows are not always indispensable to the present disclosure unless specially explicitly shown otherwise, or unless the disclosure is explicitly specified by the structures, steps and the like theoretically.

### FIRST EMBODIMENT

### 1-1. Configuration of Internal Combustion Engine of First Embodiment

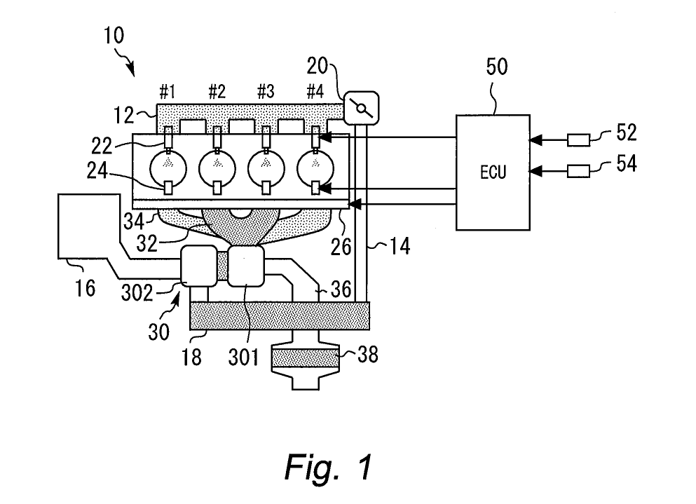

FIG. 1 is a simplified view for explaining a configuration of an internal combustion engine as a first embodiment of the present disclosure. As illustrated in FIG. 1, an internal combustion engine 10 of the present embodiment is configured as an in-line four-cylinder engine that repeats combustion in sequence of #1 to #3 to #4 to #2. An intake passage 14 is connected to the internal combustion engine 10 via an intake manifold 12, and an air cleaner 16, an intercooler 18, a throttle valve 20 and the like are provided midway in the intake passage 14. The throttle valve 20 opens and closes the intake passage 14 based on an accelerator opening degree or the like, and increases and decreases an intake air amount in accordance with the opening degree.

The respective cylinders of the internal combustion engine 10 are equipped with fuel injection valves 22 for directly injecting fuel into the respective cylinders, ignition plugs 24 for igniting a gas mixture in combustion chambers, intake valves (not illustrated) and exhaust valves (not illustrated). Note that in the present disclosure, fuel injection valves may be provided in intake ports of the respective cylinders to inject fuel. Further, in a vicinity of a crankshaft of the internal combustion engine 10, a crank angle sensor 52 for detecting a rotation angle (a crank angle) of the crankshaft is provided. Further, in a vicinity of an accelerator pedal, an accelerator position sensor 54 that detects an accelerator pedal position is installed.

The exhaust valve is equipped with a variable valve timing mechanism 26 capable of changing an opening timing of the exhaust valve. As the variable valve timing mechanism 26, the present embodiment uses a mechanism that advances or retards an opening and closing timing with a working angle kept constant, by changing a phase angle of a camshaft to the crankshaft. Hereinafter, the variable valve timing mechanism 26 will be also referred to as the “EX-VVT 26”.

The internal combustion engine 10 is equipped with a turbocharger 30. The turbocharger 30 has a turbine 301 that is operated by energy of exhaust gas of the internal combustion engine 10, and a compressor 302 that is driven by the turbine 301. The intake passage 14 described above is connected to the compressor 302. By the compressor 302, intake air can be compressed.

The turbine 301 has two inlet ports. That is, the turbocharger 30 is configured as a twin entry type turbocharger. Details of an internal configuration of the turbocharger 30 will be described later. A first exhaust manifold 32 is connected to one of the inlet ports of the turbine 301, and a second exhaust manifold 34 is connected to the other inlet port. The first exhaust manifold 32 is connected to cylinder #2 and cylinder #3. That is, exhaust gas that is discharged from cylinder #2 and exhaust gas that is discharged from cylinder #3 join each other in the first exhaust manifold 32, and flow into the one of the inlet ports of the turbine 301. Hereinafter, a cylinder group which is configured by cylinder #2 and cylinder #3 will be referred to as “a first cylinder group”.

Meanwhile, the second exhaust manifold 34 is connected to cylinder #1 and cylinder #4. That is, exhaust gas that is discharged from cylinder #1 and exhaust gas that is discharged from cylinder #4 join each other in the second exhaust manifold 34, and flows into the other inlet port of the turbine 301. Hereinafter, a cylinder group that is configured by cylinder #1 and cylinder #4 will be referred to as “a second cylinder group”. According to the twin entry type turbocharger 30 like this, interference of exhaust pulsations among the cylinders can be restrained, and excellent turbocharging characteristics can be obtained.

An exhaust passage 36 is connected to an outlet port of the turbine 301. A catalyst 38 that purifies exhaust gas is installed midway in the exhaust passage 36. The catalyst 38 is configured by a three-way catalyst, for example.

Further, a system of the present embodiment includes an ECU (Electronic Control Unit) 50 as a control device for the internal combustion engine 10. The ECU 50 includes at least an input/output interface, a memory and a CPU (a processor). The input/output interface is provided to take in sensor signals from various sensors attached to the internal combustion engine, and output operation signals to actuators included by the internal combustion engine. The sensors from which the ECU 50 takes in signals include various sensors that are necessary to control the internal combustion engine, such as the crank angle sensor 52 and the accelerator position sensor 54 which are described above, and a pressure sensor 56 that will be described later. The actuators to which the ECU 50 issues the operation signals include various actuators such as the throttle valve 20, the fuel injection valve 22, and the EX-VVT 26 which are described above, and a WGV 40 that will be described later. Various control programs for controlling the internal combustion engine, maps and the like are stored in the memory. The CPU (the processor) reads the control program or the like from the memory and executes the control program or the like, and generates an operation signal based on a sensor signal which is taken in.

### 1-2. Configuration of Turbocharger

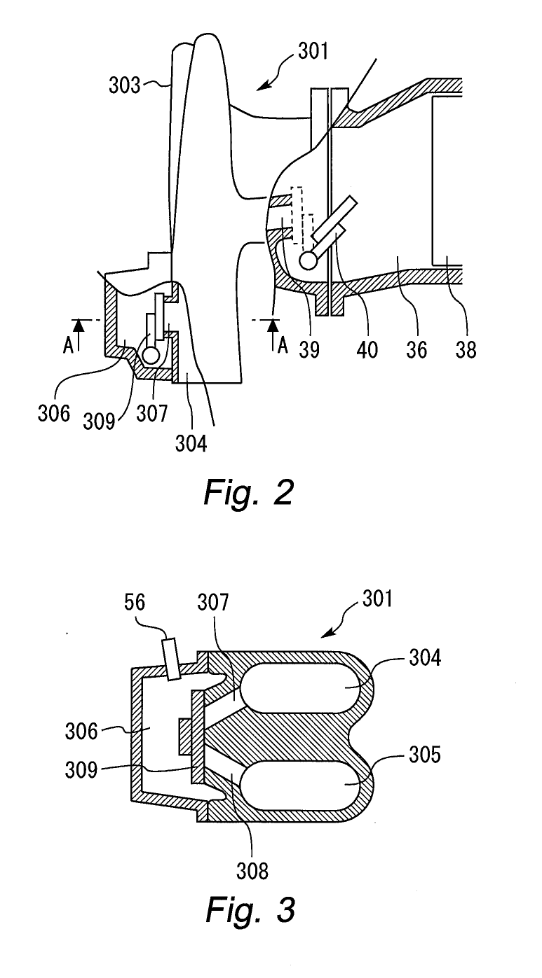

FIG. 2 is a view schematically illustrating an internal structure of the turbine of the turbocharger in the first embodiment. Further, FIG. 3 is a sectional view of the turbine in FIG. 2 cut along line A-A in FIG. 2. The turbocharger 30 includes a turbine wheel (not illustrated) that is disposed in the exhaust passage 36, a compressor impeller (not illustrated) that is disposed in the intake passage 14, a connection shaft (not illustrated) that connects the turbine wheel and the compressor impeller to be integrally rotatable, and the like. When the turbine wheel disposed in the exhaust passage 36 rotates by energy of the exhaust gas, the compressor impeller disposed in the intake passage 14 rotates with this. Subsequently, intake air is turbocharged by the rotation of the compressor impeller, and the turbocharged air is forcefully fed into combustion chambers of respective cylinders #1 to #4 of the internal combustion engine 10.

The turbine wheel is accommodated in a turbine housing 303 of the turbine 301. A scroll chamber of the turbocharger 30 is divided into a first scroll chamber and a second scroll chamber (neither of them is illustrated). The turbocharger 30 includes a first exhaust passage 304 that communicates with the first scroll chamber and a second exhaust passage 305 that communicates with the second scroll chamber. The first exhaust manifold 32 described above is connected to an inlet port of the first exhaust passage 304, and the second exhaust manifold 34 is connected to an inlet port of the second exhaust passage 305. Thereby, the exhaust gas of the first cylinder group is introduced into the first scroll chamber through the first exhaust manifold 32 and the first exhaust passage 304. Meanwhile, the exhaust gas of the second cylinder group is introduced into the second scroll chamber through the second exhaust manifold 34 and the second exhaust passage 305.

An auxiliary chamber 306 as a closed space is provided in a vicinity of the inlet ports of the first exhaust passage 304 and the second exhaust passage 305. The first exhaust passage 304 and the auxiliary chamber 306 are caused to communicate with each other by a first communication path 307, and the second exhaust passage 305 and the auxiliary chamber 306 are caused to communicate with each other by a second communication path 308. Further, in a communication portion of the first communication path 307 and the second communication path 308, and the auxiliary chamber 306, a communication valve 309 is provided. The communication valve 309 is a valve for providing/cutting off communication to the auxiliary chamber 306 from the first communication path 307 and the second communication path 308. The ECU 50 causes the communication valve 309 to operate based on an operating state of the internal combustion engine 10. In the auxiliary chamber 306, a pressure sensor 56 that detects pressure of the exhaust gas in the auxiliary chamber 306 is provided as a sensor that detects a state parameter of the exhaust gas in the auxiliary chamber 306.

In a vicinity of the turbine 301, a bypass passage 39 capable of causing a part of the exhaust gas in the first exhaust passage 304 and the second exhaust passage 305 to flow into the exhaust passage 36 at a downstream side of the turbine 301 without passing through the turbine 301, and a waste-gate valve (WGV) 40 that opens and closes the bypass passage 39 are provided. The ECU 50 causes the WGV 40 to operate based on the operating state of the internal combustion engine 10.

### 2. CHARACTERISTIC OPERATION OF SYSTEM OF FIRST EMBODIMENT

### 2-1. Opening and Closing Control of Communication Valve

As described above, according to the twin entry type turbocharger, interference of the exhaust pulsations among the cylinders can be restrained, and therefore, excellent turbocharging characteristics can be obtained. Note that a twin entry type turbocharger is suitable for increasing full-load torque in a low engine speed region of an internal combustion engine, but has the problem that in a high load region, exhaust resistance becomes high and the output is restricted due to a structure thereof. Meanwhile, an ordinary single entry type turbocharger cannot take out sufficient exhaust energy in a low engine speed region, and therefore, cannot obtain output performance in the low engine speed region.

Thus, the twin entry type turbocharger of the system of the present embodiment includes the communication valve 309 for providing/cutting off communication between the first communication path 307 and the second communication path 308. Opening and closing of the communication valve 309 are controlled in accordance with the operating state of the internal combustion engine 10. More specifically, the ECU 50 closes the communication valve 309 to cut off communication between the first communication path 307 and the second communication path 308 in the low engine speed region of the internal combustion engine 10. Thereby, the turbocharger 30 functions as a twin entry type turbocharger. Meanwhile, the ECU 50 opens the communication valve 309 to provide communication between the first communication path 307 and the second communication path 308 in the high engine speed and high load region of the internal combustion engine 10. Thereby, the turbocharger 30 functions as an ordinary single entry type turbocharger. In this way, according to the twin entry type turbocharger including the communication valve 309, high output performance can be obtained irrespective of the operating state of the internal combustion engine 10.

### 2-2. Abnormality Diagnosis for Communication Valve

The communication valve 309 is a movable component that is exposed to high temperature exhaust gas, and therefore a valve closure failure and a valve opening failure are likely to occur. A valve closure failure or a valve opening failure of the communication valve 309 can be determined based on a change over time of the pressure in the auxiliary chamber 306. That is, when the communication valve 309 is closed normally, an inside of the auxiliary chamber 306 is in a state where communication with the first exhaust passage 304 and the second exhaust passage 305 is cut off. In this case, no change occurs to a state of the gas in the auxiliary chamber 306. Meanwhile, when the communication valve 309 is opened, gas exchange is performed between the inside of the auxiliary chamber 306, and the first exhaust passage 304 and the second exhaust passage 305, and therefore, a change occurs to the state of the gas in the auxiliary chamber 306. As the state parameter expressing the state of the gas in the auxiliary chamber 306, a pressure, a temperature and the like are conceivable, and in particular, a change of the pressure is reflected in a value even when an amount of gas exchange in the auxiliary chamber 306 is small. Therefore, it becomes possible to determine whether or not a valve closure failure or a valve opening failure occurs to the communication valve 309, by detecting the change over time of the pressure of the exhaust gas in the auxiliary chamber 306 by the pressure sensor 56. Hereinafter, specific processing that is executed in the case of diagnosing an abnormality of the communication valve 309 will be described in detail by using a flowchart.

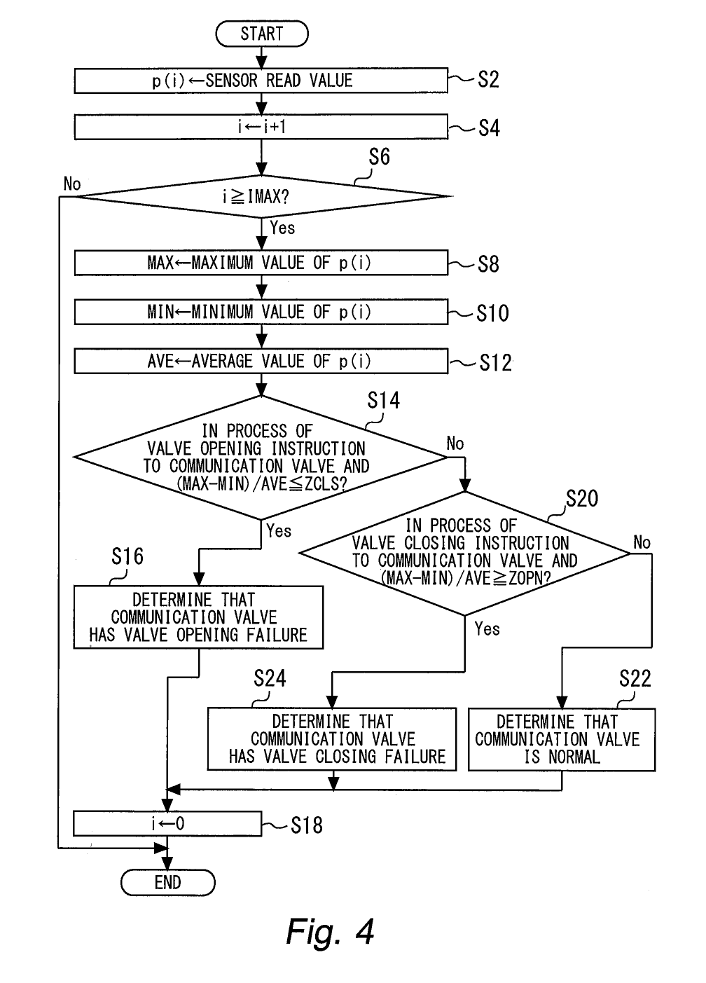

FIG. 4 is a flowchart of a control routine executed by the ECU 50 in the case of performing abnormality diagnosis for the communication valve 309. Note that the present control routine is executed every predetermined crank angle (for example, 30 degrees). In the control routine, a pressure p(i) (initial value; i=0) in the auxiliary chamber 306 that is detected by the pressure sensor 56 is read first (step S2). Next, a variable i is incremented to i+1 (step S4). Next, establishment of i≧MAX is determined (step S6). IMAX is a value corresponding to a crank angle period at which abnormality diagnosis of the communication valve 309 is executed, and is set as IMAX=6 when the crank angle period is 180 degrees, whereas when the crank angle period is 720 degrees, IMAX is set as IMAX=24. When establishment of i≧IMAX is not recognized as a result of the determination in step S6, it is determined that the crank angle period does not reach the crank angle period at which abnormality diagnosis of the communication valve 309 is executed, yet, and the present control routine is ended.

When establishment of i≧MAX is recognized as the result of determination in step S6 described above, it is determined that the crank angle period reaches the crank angle period at which abnormality diagnosis of the communication valve 309 is executed, the flow shifts to a next step, and a maximum value MAX of p(i) (i=0, 1, 2, . . . , 5) is calculated (step S8). Next, a minimum value MIN of p(i) is calculated (step S10). Next, an average value AVE of p(i) is calculated (step S12). Note that if MAX or MIN that is calculated significantly deviates as compared with MAX or MIN of the past, in steps S8 and S10 described above, MAX or MIN that is calculated may be determined as noise and excluded.

Next, it is determined whether the communication valve 309 is in process of being instructed to open, and (MAX−MIN)/AVE≦ZCLS is established (step S14). (MAX−MIN)/AVE is a value that relates to a time variation of the pressure in the auxiliary chamber 306, and becomes a larger value as a variation range of the pressure in the auxiliary chamber 306 is larger. ZCLS represents a threshold value of (MAX−MIN)/AVE for determining whether or not the communication valve 309 is opened normally, and is set at a value that is smaller than a minimum value of (MAX−MIN)/AVE that can be taken when the communication valve 309 is opened normally, for example. As a result, when it is recognized that the communication valve 309 is in process of being instructed to open and (MAX−MIN)/AVE≦ZCLS is established, it is determined that variation of the pressure in the auxiliary chamber 306 is small because the communication valve 309 is closed, and it is determined that a valve opening failure occurs to the communication valve 309 at the present time point (step S16). Subsequently, the variable i is cleared to zero (step S18), and the present control routine is ended.

When it is not recognized that the communication valve 309 is in process of being instructed to open and (MAX−MIN)/AVE≦ZCLS is established in step S14 described above, it is determined that a valve opening failure of the communication valve 309 does not occur in at least the present time point, and it is determined whether the communication valve 309 is in process of being instructed to close and (MAX−MIN)/AVE≧ZOPN is established next (step S20). ZOPN is a threshold value of (MAX−MIN)/AVE for determining whether or not the communication valve 309 is closed normally, and is set at a value that is larger than a maximum value of (MAX−MIN)/AVE that can be taken when the communication valve 309 is closed normally, for example. When it is not recognized that the communication valve 309 is in process of being instructed to close and (MAX−MIN)/AVE≧ZOPN is established as a result, it is determined that a valve opening failure and a valve closing failure of the communication valve 309 do not occur at the present time point, and the communication valve 309 is determined as normal (step S22). Subsequently, the variable i is cleared to zero in step S18 described above, and the present control routine is ended.

When it is recognized that the communication valve 309 is in process of being instructed to close and (MAX−MIN)/AVE≧ZOPN is established in step S20 described above, it is determined that the variation of the pressure in the auxiliary chamber 306 is large because the communication valve 309 is opened, and it is determined that a valve closure failure of the communication valve 309 occurs at the present point of time (step S24). Subsequently, the variable i is cleared to zero in step S18 described above, and the present control routine is ended.

In this way, presence or absence of a valve closure failure and a valve opening failure of the communication valve 309 can be determined based on the change over time of the pressure in the auxiliary chamber 306, and therefore, even when the output of the pressure sensor drifts due to deterioration over time, presence or absence of abnormality can be diagnosed.

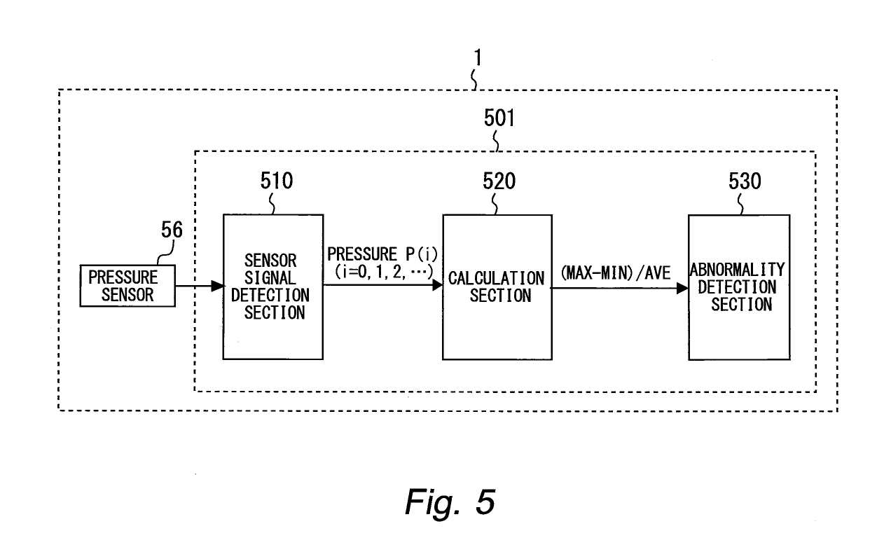

Note that the abnormality diagnosis of the communication valve 309 described above is realized by an abnormality diagnosis device 1. FIG. 5 is a functional block diagram illustrating a configuration of the abnormality diagnosis device 1 for the communication valve 309. The abnormality diagnosis device 1 is configured by the pressure sensor 56 and a control device 501. The control device 501 is a part of a processing circuit of the ECU 50, and is for realizing a function for detecting presence or absence of abnormality of the communication valve 309.

The control device 501 is configured by a sensor signal detection section 510, a calculation section 520 and an abnormality detection section 530. The sensor signal detection section 510 detects a sensor signal p(i) (i=0, 1, 2, . . . 5) of the pressure sensor 56 at predetermined crank angles. The calculation unit 520 receives input of p(i), calculates MAX, MIN and AVE respectively from the pressures, and calculates (MAX−MIN)/AVE as a value relating to the change over time of the pressure. Subsequently, the abnormality detection section 530 determines whether or not there is abnormality of a valve opening failure of the communication valve 309 depending on whether or not (MAX−MIN)/AVE that is inputted during valve opening instruction to the communication valve 309 is ZCLS or less. Further, the abnormality detection section 530 determines whether or not there is abnormality of a valve closure failure of the communication valve depending on whether or not (MAX−MIN)/AVE that is inputted during valve closing instruction to the communication valve 309 is ZOPN or more.

Respective functions of the sensor signal detection section 510, the calculation section 520 and the abnormality detection section 530 in the control device 501 are realized by the processing circuit. That is, the control device 501 includes the processing circuit for detecting the sensor signal p(i) (i=0, 1, 2, . . . 5) of the pressure sensor 56 at each predetermined crank angle, calculating (MAX−MIN)/AVE from these pressures p(i), and determining whether or not there is abnormality of a valve opening failure of the communication valve 309 depending on whether or not (MAX−MIN)/AVE that is inputted during valve opening instruction to the communication valve 309 is ZCLS or less, or determining whether or not there is abnormality of a valve closure failure of the communication valve 309 depending on whether or not (MAX−MIN)/AVE that is inputted during valve closure instruction to the communication valve 309 is ZOPN or more. The processing circuit is a CPU (Central Processing Unit, also referred to as a central processor, a processing unit, an arithmetic unit, a microprocessor, a microcomputer, a processor, and a DSP) that executes the programs stored in the memory.

The functions of the sensor signal detection section 510, the calculation section 520 and the abnormality detection section 530 are realized by software, firmware, or a combination of software and firmware. The software and the firmware are described as programs, and are stored in the memory. The processing circuit realizes the functions of the respective sections by reading and executing the program stored in the memory. That is, the control device includes the memory for storing the program by which the following steps are resultantly executed when the program is realized by the processing circuit: a step of detecting the sensor signal p(i) (i=0, 2, . . . 5) of the pressure sensor 56 at each predetermined crank angles, a step of calculating (MAX−MIN)/AVE from these pressures p(i), a step of determining whether or not there is abnormality of a valve opening failure of the communication valve 309 depending on whether or not (MAX−MIN)/AVE that is inputted during valve opening instruction to the communication valve 309 is ZCLS or less, or a step of determining whether or not there is abnormality of a valve closure failure of the communication valve 309 depending on whether or not (MAX−MIN)/AVE that is inputted during valve closure instruction to the communication valve 309 is ZOPN or more. Further, these programs can be said to be what causes a computer to execute procedures and methods of the sensor signal detection section 510, the calculation section 520 and the abnormality detection section 530. Here, as the memory, a nonvolatile or volatile semiconductor memory such as a RAM, a ROM, a flash memory, an EPROM or an EEPROM is applicable.

In the system of the aforementioned first embodiment, the ECU 50 executes the processing in steps S2 to S6 illustrated in FIG. 4, whereby the function of the sensor signal detection section 510 in the control device 501 is realized. The ECU executes the processing in steps S8 to S12, whereby the function of the calculation section 520 in the control device 501 is realized, and the ECU executes the processing in steps S14 to S24, whereby the function of the abnormality detection section 530 in the control device 501 is realized.

### 2-3. Control at Time of Valve Closure Failure of Communication Valve

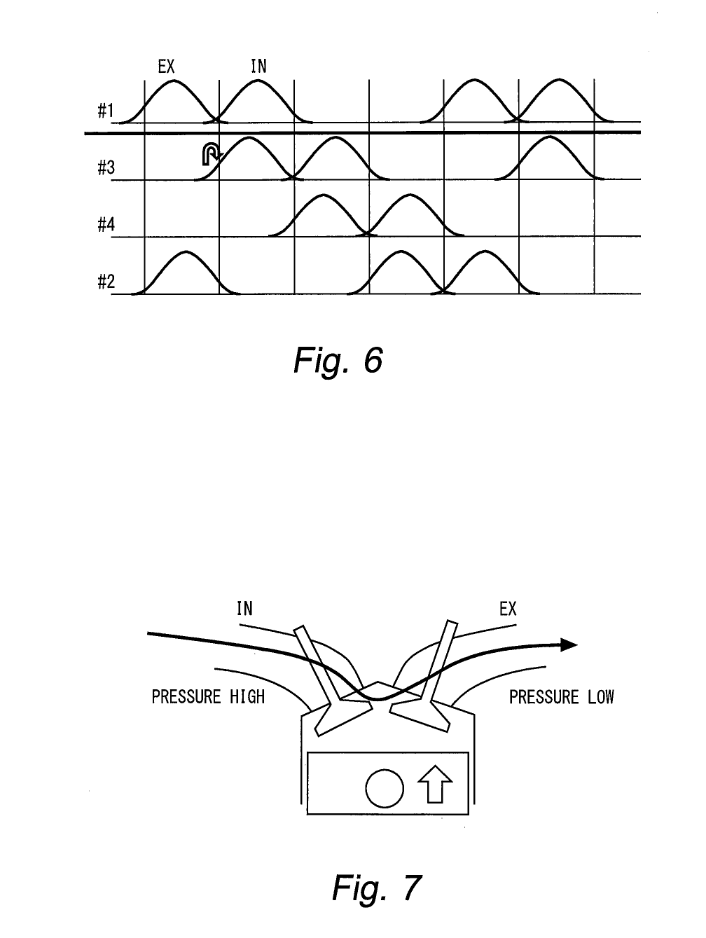

As described above, in the communication valve 309, there is the fear of occurrence of a valve closure failure and a valve opening failure. FIG. 6 is a diagram illustrating valve opening characteristics of the intake valves and the exhaust valves of the respective cylinders of the internal combustion engine in a state where the communication valve is closed normally. Note that IN in FIG. 6 shows a valve opening characteristic of the intake valve, and EX shows a valve opening characteristic of the exhaust valve respectively. In an example illustrated in FIG. 6, in a latter stage of the exhaust stroke of cylinder #1, the intake valve is opened before the exhaust valve is closed, and thereby a period of a so-called valve overlap in which both the exhaust valve and the intake valve are opened is provided. A period (hereinafter, referred to as “a blowdown period”) in which a blowdown flow of cylinder #3 in which combustion is performed next to cylinder #1 is exhausted (hereinafter, referred to as “a blowdown period”) is synchronized with the valve overlap period of cylinder #1.

In the state where the communication valve 309 is closed normally, the exhaust path of cylinder #3 and the exhaust path of cylinder #1 are completely separated from each other. In this case, exhaust gas by blowdown does not blow back to the exhaust path of cylinder #1, and therefore, the pressure at the intake port side in the valve overlap period of cylinder #1 is higher than pressure at the exhaust port side. FIG. 7 is a view schematically illustrating a flow of gas in the cylinder in the valve overlap period in the state where the communication valve is closed normally. When the pressure at the intake port side is higher than the pressure at the exhaust port side as illustrated in FIG. 7, burnt gas in the cylinder is replaced with fresh air during the valve overlap period. Thereby, a charging efficiency is enhanced, and therefore reduction in engine output power is restrained.

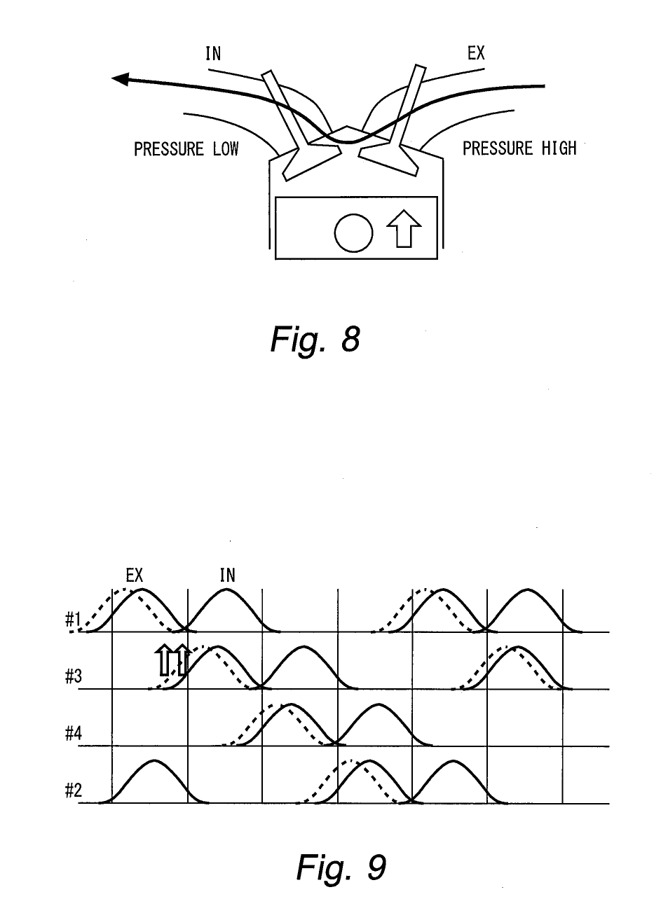

In contrast with this, in a state where a valve closure failure in which the communication valve 309 is not closed normally occurs, exhaust gas by blowdown of cylinder #3 blows back to the exhaust path of cylinder #1. FIG. 8 is a view schematically illustrating a flow of the gas in the cylinder in the valve overlap period in a state where a valve closure failure occurs to the communication valve. As illustrated in FIG. 8, in the state where the communication valve 309 is not closed normally, the exhaust gas by blowdown of cylinder #3 blows back to the exhaust path of cylinder #1, and as a result, the pressure of the exhaust port of cylinder #1 becomes higher than the pressure of the intake port. In this case, exhaust gas also flows around to a side of the intake port, and the charging efficiency is reduced. Further, in the state where the communication valve 309 is not closed normally, the capacity of the exhaust path increases, and therefore reduction in output power due to reduction in the turbocharging pressure also occurs.

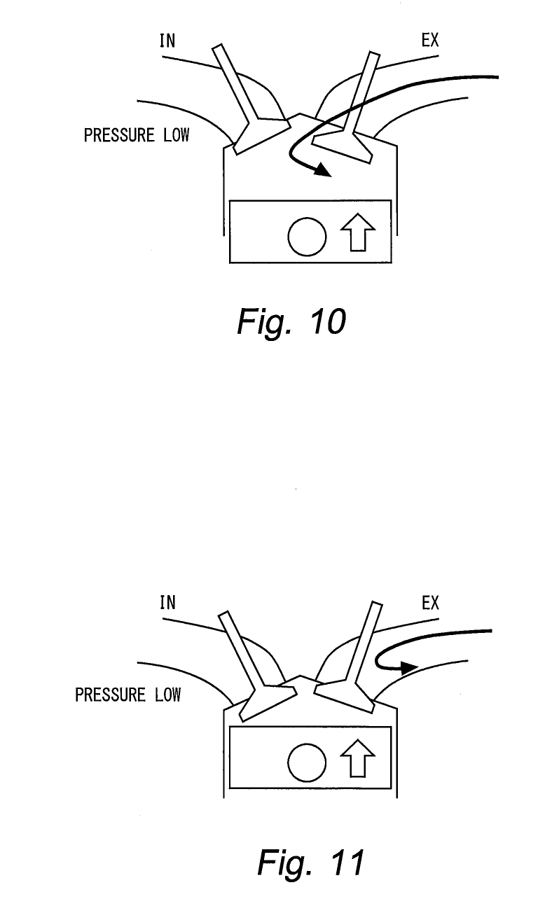

Thus, in the system of the present embodiment, in a case where a valve closure failure occurs to the communication valve 309, the opening and closing timing of the exhaust valve is advanced more than in the case where a valve closure failure does not occur (that is, in the case where normal control of the internal combustion engine is performed) by operating the EX-VVT 26. FIG. 9 is a diagram illustrating valve opening characteristics of the intake valves and the exhaust valves of the respective cylinders of the internal combustion engine in the state where a valve closure failure occurs to the communication valve. Note that in FIG. 9, waveforms illustrated by solid lines represent valve opening characteristics in the case of the communication valve being closed normally, and waveforms illustrated by broken lines represent valve opening characteristics of the exhaust valves in the case of a valve closure failure occurring to the communication valve, respectively. Further, FIG. 10 is a view schematically illustrating a flow of gas in the cylinder in a vicinity of an intake top dead center and before valve opening of the intake valve in a case where the opening and closing timing of the exhaust valve is advanced, in the state where a valve closure failure occurs to the communication valve. Further, FIG. 11 is a view schematically illustrating the flow of the gas in the cylinder in the vicinity of the intake top dead center and before valve opening of the intake valve in the case where the opening and closing timing of the exhaust valve is advanced, in the state where a valve closure failure occurs to the communication valve.

As illustrated in FIG. 9, the closing timing of the exhaust valve is advanced when a valve opening phase of the exhaust valve is advanced, so that with this, the valve overlap period of cylinder #1 becomes short. In this case, as illustrated in FIG. 11, the blowdown flow of cylinder #3 is restrained from flowing around to cylinder #1, and therefore combustion abnormality such as a misfire due to reduction in charge efficiency is restrained. Further, when the opening and closing timing of the exhaust valve is advanced as illustrated in FIG. 10, the opening timing of the exhaust valve is advanced, but the intake valve is not opened in the vicinity of the intake port and before valve opening of the intake valve, and therefore, burnt gas does not flow around to the intake port. Further, when the opening timing of the exhaust valve is advanced, the blowdown period of cylinder #3 is advanced with this. Thereby, the blowdown period of cylinder #3 can be advanced with respect to the valve overlap period of cylinder #1, and therefore, it becomes possible to restrain the exhaust gas from flowing around to cylinder #1 more.

Note that when the exhaust valve is closed before reaching a top dead center (TDC) by the closing timing of the exhaust valve being advanced, the burnt gas (residual gas) remaining in the cylinder increases. However, a residual gas amount that increases by the closing timing of the exhaust valve being advanced is smaller as compared with a restraint amount of the exhaust gas flowing around which is described above, and therefore it becomes possible to reduce the amount of the exhaust gas that remains in the cylinder by advancing the opening and closing timing of the exhaust valve.

### 2-4. Ignition Timing Control at Time of Valve Closure Failure of Communication Valve

As described above, when the valve overlap period is reduced at the time of the valve closure failure of the communication valve 309, a ratio of the burnt gas in the cylinder is increased, and a possibility of a misfire is increased. Thus, in the system of the present embodiment, the ignition timing is retarded more than the ignition timing (for example, minimum advance for the best torque; MBT) at the time of normal control. Thereby, it becomes possible to restrain occurrence of a misfire effectively.

### 2-5. Control at Time of Vale Opening Failure of Communication Valve

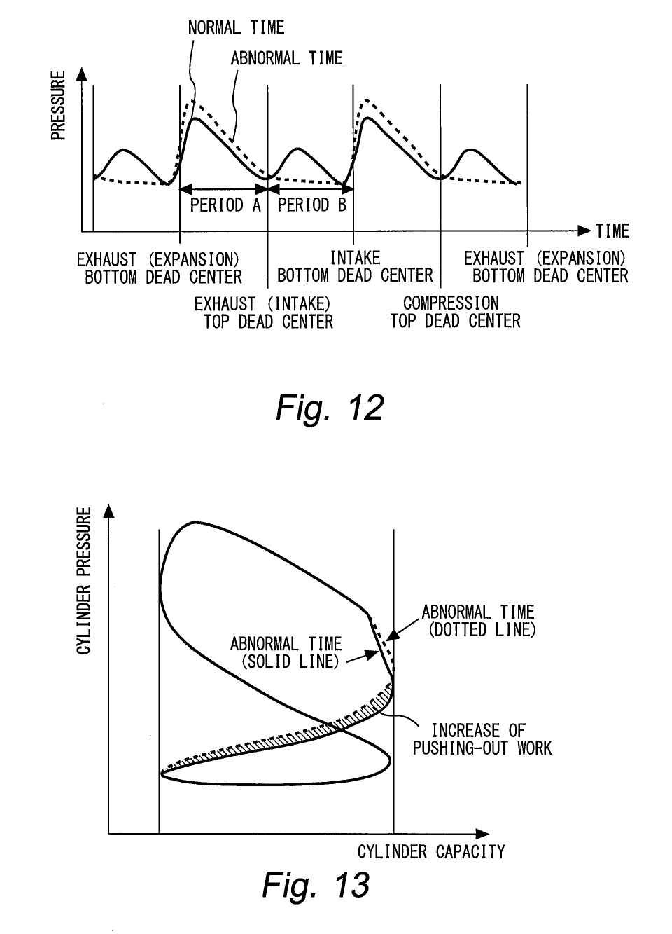

As described above, in the communication valve 309, there is the fear of occurrence of a valve closure failure. FIG. 12 is a diagram illustrating a pressure waveform of the exhaust port at a time of a high engine speed and a high load of a predetermined cylinder. Further, FIG. 13 is a diagram illustrating a pressure waveform of a cylinder pressure to a cylinder capacity at the time of the high engine speed and the high load of a predetermined cylinder. Solid lines in these drawings respectively illustrate pressure waveforms in a case where the communication valve 309 opens normally, and broken lines illustrate pressure waveforms in a case where a valve opening failure occurs to the communication valve 309. As illustrated in FIG. 12, in a period A that is an exhaust stroke of a predetermined cylinder (cylinder #1, for example), the pressure of the exhaust port at the time of a valve opening failure becomes larger throughout an entire region than the pressure at a normal time. This is because an exhaust capacity becomes large when the communication valve 309 normally opens, and therefore, a pressure increase at a time of blowdown becomes small. Consequently, an exhaust gas pushing out work at the time of a valve opening failure increases more than an exhaust gas pushing-out work at a normal time. Further, a period B that is an intake stroke of cylinder #1 is synchronized with an exhaust stroke of cylinder #3 that is a cylinder where combustion takes place next. Consequently, in the intake stroke of cylinder #1 in which the communication valve 309 normally opens, the blowdown of cylinder #3 flowing around occurs. However, the period B does not correspond to the exhaust stroke of cylinder #1, and therefore, has nothing to do with increase and decrease of the exhaust gas pushing-out work. In this way, when abnormality of a valve opening failure occurs to the communication valve 309, the engine output power is reduced due to increase in the exhaust gas pushing-out work.

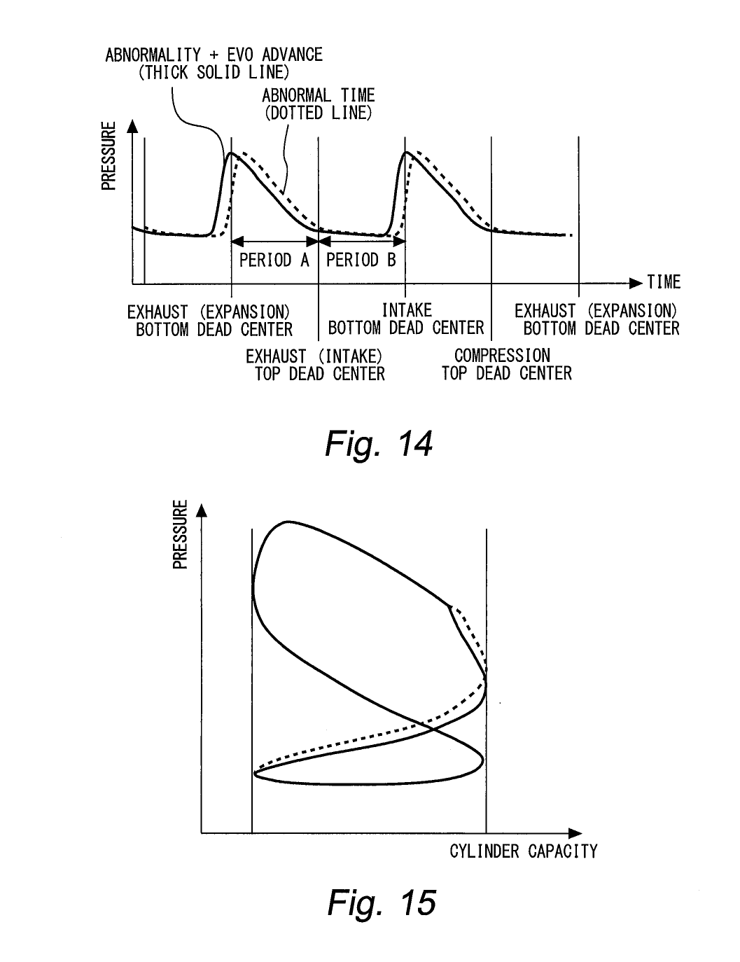

Thus, in the system of the present embodiment, control of advancing an opening timing of the exhaust valve (EVO) is performed when a valve opening failure occurs to the communication valve 309. FIG. 14 is a diagram illustrating a pressure waveform of the exhaust port at a time of a high engine speed and a high load of a predetermined cylinder. Further, FIG. 15 is a diagram illustrating a pressure waveform of the cylinder pressure to the cylinder capacity at the time of the high engine speed and high load of the predetermined cylinder. The broken lines in these drawings illustrate the pressure waveforms in the case of a valve opening failure occurs to the communication valve 309, and the solid lines illustrates the pressure waveforms in the case of the opening timing of the exhaust valve (EVO) is advanced when a valve opening failure occurs to the communication valve 309, respectively.

As illustrated in FIG. 14, when the valve opening timing of the exhaust valve (EVO) is advanced, the pressure of the exhaust port is reduced in the period A that is an exhaust stroke of the target cylinder. Thereby, increase of the exhaust gas pushing-out work in the case of an abnormality of a valve opening failure occurs to the communication valve 309 can be restrained, and therefore it becomes possible to prevent reduction of the engine output power.

### 2-6. Fuel Increase Control at Time of Valve Opening Failure of Communication Valve

When the valve opening timing of the exhaust valve (EVO) is advanced, the exhaust gas temperature increases, and with this, the temperature of the catalyst tends to increase. Thus, in the system of the present embodiment, fuel increase control of increasing an amount of fuel supply into the cylinder more than in a case where the valve opening timing of the exhaust valve is not advanced is executed, when a valve opening failure occurs to the communication valve 309 and the valve opening timing of the exhaust valve is advanced. Thereby, it becomes possible to restrain an excessive temperature increase of the catalyst due to the valve opening timing of the exhaust valve being advanced.

### 3. SPECIFIC PROCESSING OF CONTROL EXECUTED AT TIME OF FAILURE OF COMMUNICATION VALVE

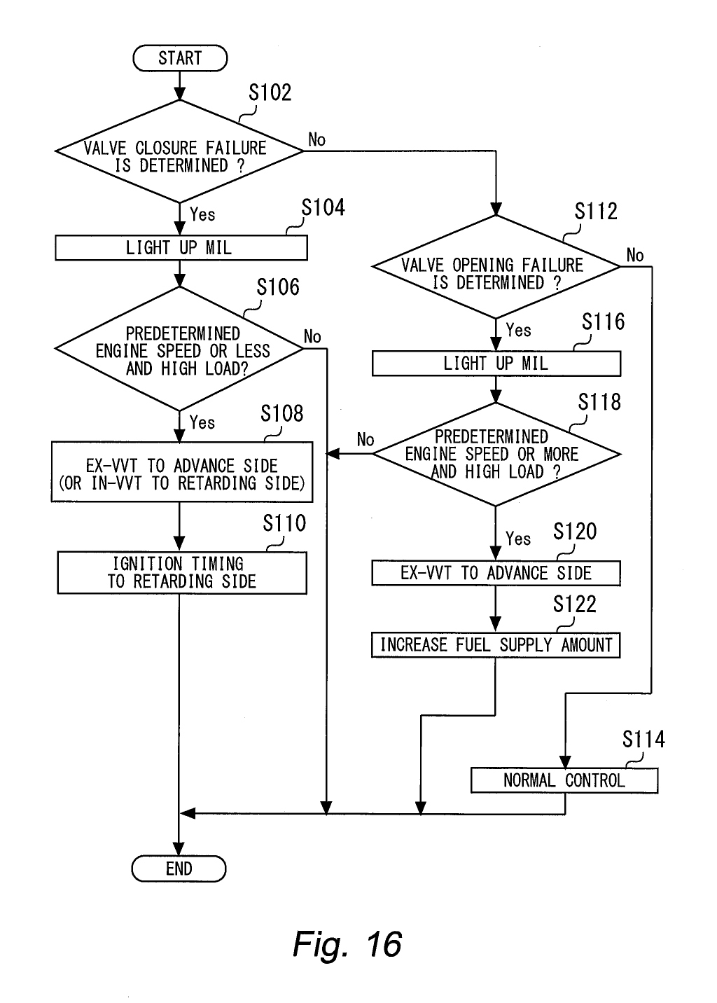

FIG. 16 is a flowchart illustrating a control routine of control that is executed in the system of the first embodiment. Note that the control routine is executed every predetermined control period (for example, a crank angle of 180 degrees or 720 degrees). In the control routine illustrated in FIG. 16, it is determined whether or not a valve closure failure of the communication valve 309 occurs (step S102). Here, more specifically, a diagnosis result by the routine illustrated in FIG. 4 described above is used. When it is determined that a valve closure failure of the communication valve 309 occurs as a result, the flow shifts to the next step, and the MIL is lit up (step S104). Thereby, it is notified that abnormality occurs to the communication valve 309. Next, it is determined whether or not the operating state of the internal combustion engine 10 is in a region of a predetermined engine speed or less and a high load (step S106). Note that the region of the predetermined engine speed or less and a high load indicates at least a turbocharging region in the region where a valve closing instruction is issued to the communication valve 309. When establishment of the condition in step S106 is not recognized as a result, it is determined that a malfunction due to a valve closure failure of the communication valve 309 does not occur at a present point of time, and the present control routine is ended.

Meanwhile, when establishment of the condition of step S106 described above is recognized, it is determined that abnormal combustion due to the valve closure failure of the communication valve 309 occurs, the flow shifts to the next step, the EX-VVT 26 is operated, and the exhaust valve timing phase is advanced (step S108). Thereby, the valve overlap period is reduced. Next, an ignition timing is retarded to be later than the ignition timing at the normal control time (step S110), and the present control routine is ended.

Further, when it is determined that a valve closure failure of the communication valve 309 does not occur in step S102 described above, the flow shifts to the next step, and it is determined whether or not a valve opening failure of the communication valve 309 occurs (step S112). Here, more specifically, the diagnosis result by the routine illustrated in FIG. 4 described above is used. When it is determined that a valve opening failure of the communication valve 309 does not occur as a result, it is determined that the communication valve 309 operates normally, and the normal control based on the operating state of the internal combustion engine 10 is executed (step S114).

When it is determined that a valve opening failure of the communication valve 309 occurs in step 5112 described above, the flow shifts to the next step, and the MIL is lit up (step S116). Thereby, it is notified that abnormality occurs to the communication valve 309. Next, it is determined whether or not the operating state of the internal combustion engine 10 is in a region of a predetermined engine speed or more and a high load (step S118). Note that the region of the predetermined engine speed or more and the high load in this case indicates a region in which a valve opening instruction is issued to the communication valve 309. When establishment of the condition in step S118 is not recognized as a result, it is determined that a malfunction due to the valve opening failure of the communication valve 309 does not occur at a present point of time, and the present control routine is ended.

Meanwhile, when establishment of the condition of step S118 described above is recognized, it is determined that engine output power reduction due to the valve opening failure of the communication valve 309 occurs, the flow shifts to the next step, the EX-VVT 26 is operated, and the exhaust valve timing phase is advanced (step S120). Thereby, the valve opening timing of the exhaust valve (EVO) is advanced. Next, a fuel supply amount into the cylinder is increased to be larger than that at the normal control time (step S122), and the present control routine is ended.

As described above, according to the system of the first embodiment, it becomes possible to restrain occurrence of combustion abnormality such as a misfire and knocking, when a valve closure failure or a valve opening failure occurs to the communication valve 309.

Note that in the system of the first embodiment described above, the auxiliary chamber 306, the first communication path 307 and the second communication path 308 correspond to a “communication path” of a first aspect of the present disclosure, and the EX-VVT 26 corresponds to a “variable valve timing mechanism” of the first aspect of the present disclosure. The abnormality diagnosis device 1 corresponds to “an abnormality diagnosis device” of the first aspect of the present disclosure, and the ECU 50 corresponds to a “control device” of the first aspect of the present disclosure.

Further, in the system of the first embodiment described above, the ignition plug 24 corresponds to an “ignition device” of a second aspect of the present disclosure, the pressure sensor 56 corresponds to a “sensor” of a fourth aspect of the present disclosure, and the fuel injection valve 22 corresponds to a “fuel supply device” of a seventh aspect of the present disclosure.

### 4. MODIFICATION EXAMPLE

The present disclosure is not limited to the aforementioned embodiment, and can be carried out by variously modified within the range without departing from the gist of the present disclosure. For example, a modified example as follows may be adopted.

### 4-1. Configuration of Communication Valve

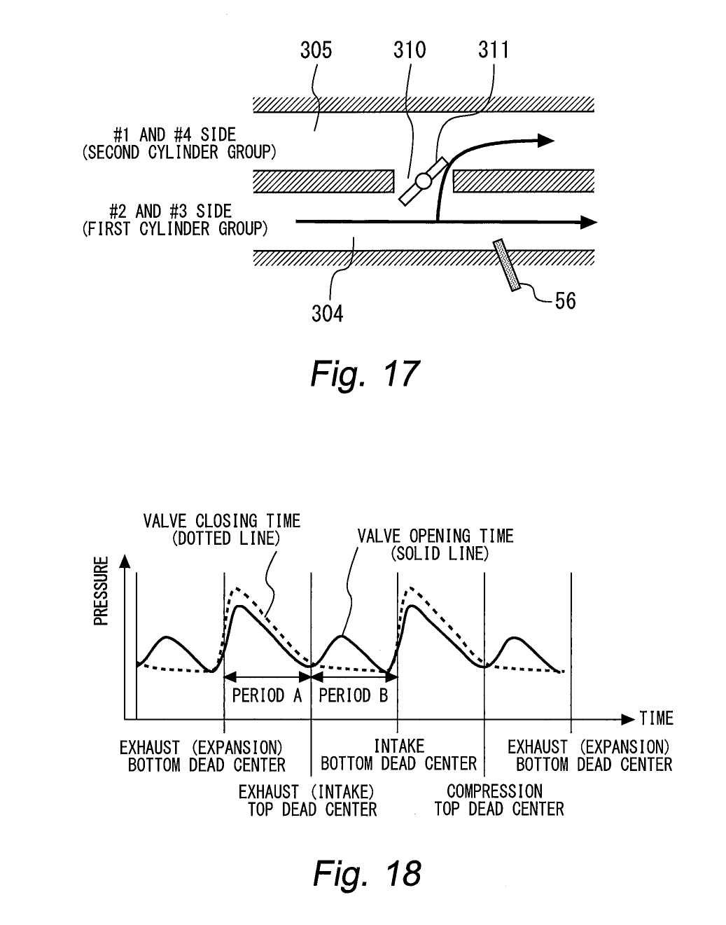

Although in the system of the first embodiment, the configuration that allows the first exhaust passage 304 and the second exhaust passage 305 to communicate with each other via the auxiliary chamber 306 by opening the communication valve 309 is adopted, a configuration that allows these exhaust passages to communicate with each other directly without using the auxiliary chamber 306 may be adopted. FIG. 17 is a view illustrating a structure of a communication valve and a neighborhood thereof as a modification example. In the structure illustrated in FIG. 17, the first exhaust passage 304 and the second exhaust passage 305 communicate with each other by a communication path 310. In the communication path 310, a communication valve 311 for opening/cutting off the communication path 310 is provided. Further, at a downstream side of the communication path 310 in the first exhaust passage 304, the pressure sensor 56 is disposed. According to the structure like this, communication/cutting off of the first exhaust passage 304 and the second exhaust passage 305 can be switched by opening/cutting off the communication path 310 by operating the communication valve 311.

Note that the abnormality diagnosis of the communication valve 311 described above can be performed by the following method, for example. FIG. 18 is a diagram illustrating a pressure change of the first exhaust passage, which is detected by the pressure sensor. A broken line in FIG. 18 represents a pressure change at a time of valve closing of the communication valve 311, and a solid line represents a pressure change at a time of valve opening of the communication valve 311, respectively. As illustrated in FIG. 18, when the communication valve 311 is opened normally, a positive pressure wave of the pressure reaches the pressure sensor 56 at intervals of 180 degrees. In contrast with this, when the communication valve 311 is closed normally, the positive pressure wave of the pressure reaches the pressure sensor 56 at intervals of 360 degrees. Thus, if a pressure maximum value or an average value in an intake stroke (a period B in FIG. 18) of cylinder #2 or cylinder #3 is calculated, and is compared with a predetermined value, it becomes possible to detect an opening and closing state of the communication valve 311.

In the system of the modification example described above, the communication valve 311 corresponds to the “communication valve” of the first aspect of the present disclosure, the communication path 310 corresponds to the “communication path” of the first aspect of the present disclosure, and the pressure sensor 56 corresponds to the “sensor” of the fourth aspect of the present disclosure.

### 4-2. State Parameter

In the aforementioned abnormality determination, abnormality determination of the communication valve 309 is performed by using the pressure in the auxiliary chamber 306, but the state parameter in the auxiliary chamber 306 that is usable in abnormality determination is not limited to this. That is, for example, a temperature in the auxiliary chamber 306 changes in accordance with opening and closing of the communication valve 309. Consequently, a temperature sensor is disposed in the auxiliary chamber 306 in place of the pressure sensor 56, and based on a variation degree of the temperature in the auxiliary chamber 306, presence or absence of a valve closure failure and a valve opening failure of the communication valve 309 may be determined. Further, other than the temperature in the auxiliary chamber 306, state parameters such as a density and a flow rate in the auxiliary chamber 306 can be used, for example.

If the temperature sensor is used, the temperature of the exhaust gas that flows into the catalyst can be accurately grasped, and therefore, whether it is necessary to execute the fuel increase control can be precisely determined. Thereby, it becomes possible to prevent unnecessary increase of fuel and restrain worsening of fuel efficiency.

Further, in the aforementioned abnormality determination, (MAX−MIN)/AVE is used as the value which relates to the variation with time of the pressure in the auxiliary chamber 306, but the usable value is not limited to this. That is, any value that enables to determine whether or not a change over time occurs to the state parameter in the auxiliary chamber 306 can be used, and a change rate of the pressure p(i) or the like can be also used, for example.

### 4-3. Reduction Control of Valve Overlap at Time of Valve Closing Failure

In the system of the first embodiment described above, as reduction control of the valve overlap at the time of a valve closure failure, the valve timing phase of the exhaust valve is advanced by operating the EX-VVT 26. However, such a configuration may be adopted that further includes a variable valve timing mechanism (hereinafter, referred to as “IN-VVT”) capable of changing a valve timing phase of the intake valve, and retards the valve timing phase of the intake valve by operating the IN-VVT to reduce the valve overlap. Further, in an internal combustion engine including a variable working angle mechanism capable of changing the working angle of the exhaust valve, such a configuration may be adopted that advances the valve closing timing of the exhaust valve (EVC) by operating the variable working angle mechanism to reduce the valve overlap. Furthermore, in an internal combustion engine including a variable working angle mechanism capable of changing a working angle of the intake valve, such a configuration may be adopted that retards a valve opening timing (IVO) of the intake valve by operating the variable working angle mechanism to reduce the valve overlap.

Further, in the system of the embodiment described above, as an execution condition of reduction control of the valve overlap at the time of a valve closure failure, it is determined whether or not the operating state of the internal combustion engine 10 is in the region of a predetermined engine speed or less and a high load. However, the execution condition of the reduction control of the valve overlap at the time of a valve closure failure is not limited to this, and it may be determined whether or not the operating state of the internal combustion engine 10 is in a region in which a valve closing instruction is issued to the communication valve 309.

### 4-4. Ignition Timing Retardation Control at Time of Valve Closure Failure

Ignition timing retardation control at the time of a valve closure failure does not have to be necessarily executed, and may be executed only when there is the fear that knocking occurs by reduction control of the valve overlap.

### 4-5. Exhaust Valve Opening Timing (EVO) Advance Control at Time of Valve Opening Failure

In the system of the first embodiment described above, as exhaust valve opening timing (EVO) advance control at the time of a valve opening failure, the valve timing phase of the exhaust valve is advanced by operating the EX-VVT 26. However, in the internal combustion engine including the variable working angle mechanism capable of changing the working angle of the exhaust valve, the configuration that advances the exhaust valve opening timing (EVO) by operating the variable working angle mechanism may be adopted. Control of operating the WGV 40 to the opening side more than at the normal time can be substituted for the exhaust valve opening timing advance control at the time of a valve opening failure. This control is effective in the feature of being capable of restraining increase of exhaust gas pushing-out loss without increasing the exhaust gas temperature excessively.

Further, in the system of the embodiment described above, as the execution condition of the reduction control of the valve overlap at the time of a valve opening failure, it is determined whether or not the operating state of the internal combustion engine 10 is in the region of the predetermined engine speed or more and a high load. However, the execution condition of the exhaust valve opening timing advance control at the time of a valve opening failure is not limited to this, and it may be determined whether or not the operating state of the internal combustion engine 10 is in the region where the valve opening instruction is issued to the communication valve 309, for example.

### 4-6. Fuel Increase Control at Time of Valve Opening Failure

Fuel increase control at the time of a valve opening failure does not have to be necessarily executed, and may be executed only when there is the fear that the temperature of the catalyst excessively increases by exhaust valve opening timing (EVO) advance control.

What is claimed is:

1. An internal combustion engine, comprising:
a first exhaust passage in which gas flows, which is discharged from a first cylinder group of the internal combustion engine including a plurality of cylinders;
a second exhaust passage in which gas flows, which is discharged from a second cylinder group that is configured by cylinders different from the first cylinder group;
a turbocharger with which the first exhaust passage and the second exhaust passage respectively communicate individually;
a communication path that causes the first exhaust passage and the second exhaust passage to communicate with each other;
a communication valve that opens and closes the communication path;
an abnormality diagnosis device that diagnoses presence or absence of abnormality of the communication valve;
a variable valve timing mechanism capable of changing a period of valve overlap in which an intake valve and an exhaust valve of the internal combustion engine are both in a valve opened state; and
a control device that opens and closes the communication valve and operates the variable valve timing mechanism, based on an operating state of the internal combustion engine,
wherein, when it is determined that abnormality of a valve closure failure of the communication valve is present by the abnormality diagnosis device, the control device operates the variable valve timing mechanism to reduce the valve overlap in an operating state in which the communication valve is closed, more than in a case where it is determined that abnormality of a valve closure failure of the communication valve is absent.

2. The internal combustion engine according to claim 1, further comprising:
an ignition device that performs ignition to a gas mixture in a combustion chamber of the internal combustion engine,
wherein, when it is determined that abnormality of a valve closure failure of the communication valve is present by the abnormality diagnosis device, the control device operates the ignition device such that an ignition timing is retarded more than in a case where it is determined that abnormality of a valve closure failure of the communication valve is absent.

3. The internal combustion engine according to claim 1,
wherein the variable valve timing mechanism is capable of changing a valve opening timing of the exhaust valve, and
when it is determined that abnormality of a valve closure failure of the communication valve is present by the abnormality diagnosis device, the control device operates the variable valve timing mechanism to advance the valve opening timing of the exhaust valve in the operating state where the communication valve is closed, more than in the case where it is determined that abnormality of a valve closure failure of the communication valve is absent.

4. The internal combustion engine according to claim 1,
wherein the communication path includes
an auxiliary chamber,
a first communication path that causes the first exhaust passage and the auxiliary chamber to communicate with each other, and
a second communication path that causes the second exhaust passage and the auxiliary chamber to communicate with each other,
wherein the communication valve is configured to perform opening and closing of the first communication path and the second communication path, and
the abnormality diagnosis device
is configured to include a sensor for detecting a state parameter expressing a state of gas in the auxiliary chamber, and diagnose presence or absence of abnormality of the communication valve based on a change over time of the state parameter detected by the sensor.

5. The internal combustion engine according to claim 1,
wherein the variable valve timing mechanism is capable of changing a valve opening timing of the exhaust valve, and
when it is determined that abnormality of a valve opening failure of the communication valve is present by the abnormality diagnosis device, the control device operates the variable valve timing mechanism to advance the valve opening timing of the exhaust valve in an operating state where the communication valve is opened, more than in a case where it is determined that abnormality of a valve opening failure of the communication valve is absent.

6. The internal combustion engine according to claim 1, further comprising:
a bypass passage that communicates with an exhaust passage downstream of the turbocharger from the first exhaust passage and the second exhaust passage; and
a waste-gate valve for adjusting an opening degree of the bypass passage,
wherein, when it is determined that abnormality of a valve opening failure of the communication valve is present by the abnormality diagnosis device, the control device adjusts an opening degree of the waste-gate valve in an operating state where the communication valve is opened, to an opening side more than in a case where it is determined that abnormality of a valve opening failure of the communication valve is absent.

7. The internal combustion engine according to claim 5, further comprising:
a fuel supply device that adjusts a fuel supply amount to a combustion chamber of the internal combustion engine,
wherein the control device is configured to control the fuel supply device to increase a fuel supply amount to the combustion chamber, when it is determined that abnormality of a valve opening failure of the communication valve is present by the abnormality diagnosis device and the control device advances a valve opening phase of the exhaust valve.
